(19) United States
(12) Patent Application Publication
(10) Pub. No.: US 2024/0321503 A1
(43) Pub. Date: Sep. 26, 2024

(54) INDUCTOR

(71) Applicant: TDK CORPORATION, Tokyo (JP)

(72) Inventors: Masashi Shimoyasu, Tokyo (JP); Takahiro Yata, Tokyo (JP); Masataka Yamamoto, Tokyo (JP); Hiroyuki Abe, Yurihonjo-city (JP); Daiki Saito, Yurihonjo-city (JP); Akihiko Oide, Tokyo (JP)

(73) Assignee: TDK CORPORATION, Tokyo (JP)

(21) Appl. No.: 18/599,609

(22) Filed: Mar. 8, 2024

(30) Foreign Application Priority Data
Mar. 20, 2023 (JP) 2023-044428

(51) Int. Cl. H01F 27/23; H01F 17/00; H01F 17/02

(52) U.S. Cl. CPC H01F 27/23; H01F 17/0013; H01F 17/02; H01F 2017/002

(57) ABSTRACT

An inductor includes: an element body having a pair of end surfaces facing each other, and a side surface extending in a facing direction of the pair of end surfaces to connect the pair of end surfaces; and a through conductor disposed inside the element body and extending in the facing direction. The element body includes a first portion surrounding the through conductor, and a second portion positioned outward of the first portion, when viewed in the facing direction. The first portion is disposed spaced from the side surface. The first portion has a porosity higher than a porosity of the second portion.

### TECHNICAL FIELD

The present disclosure relates to an inductor. The present application claims priority to Japanese Patent Application No. 2023-044428 filed on Mar. 20, 2023, the content of which is incorporated herein by reference in its entirety.

### BACKGROUND

An inductor including an element body having a pair of end surfaces, and a through conductor disposed inside the element body and extending in a facing direction of the pair of end surfaces is known (e.g., Japanese Unexamined Patent Publication No. H4-165606).

### SUMMARY

In the inductor above, the through conductor has a higher thermal shrinkage than the element body, so that cracks may form in the element body around the through conductor when the temperature returns from a high temperature during firing or mounting to a normal temperature.

It is an object of the present disclosure to provide an inductor that is capable of suppressing cracks in the element body caused by changes in temperature.

An inductor according to one aspect of the present disclosure includes an element body having a pair of end surfaces facing each other, and a side surface extending in a facing direction of the pair of end surfaces to connect the pair of end surfaces, and a through conductor disposed inside the element body and extending in the facing direction, wherein the element body includes a first portion surrounding the through conductor, and a second portion positioned outward of the first portion, when viewed in the facing direction, wherein the first portion is disposed spaced from the side surface, and wherein the first portion has a porosity higher than a porosity of the second portion.

In the inductor above, the porosity of the first portion of the element body surrounding the through conductor is higher than the porosity of the second portion of the element body positioned outward of the first portion. Generally, in a ceramic material, the Young's modulus decreases as porosity increases. Thus, the first portion is capable of relieving tensile stress applied to the element body via thermal shrinkage of the through conductor. As a result, cracks in the element body caused by changes in temperature can be suppressed. The first portion is disposed spaced from the side surface, and is not exposed at the side surface. Consequently, cracks and corrosion caused by exposed portions of the first portion at the side surface can be suppressed.

The element body may further include a third portion disposed between the first portion and the second portion, and the third portion may have a porosity lower than the porosity of the first portion and higher than the porosity of the second portion. In this case, cracks in the element body caused by changes in temperature can be more reliably suppressed.

An outer edge of the first portion may have a similar shape to an outer edge of the through conductor when viewed in the facing direction. In this case, the first portion is capable of covering the periphery of the through conductor with a uniform thickness. Thus, cracks in the element body caused by changes in temperature can be more reliably suppressed.

The first portion may be in contact with the through conductor. In this case, cracks in the element body caused by changes in temperature can be more reliably suppressed.

A length of the first portion in the facing direction may be equal to a length of the through conductor in the facing direction. In this case, the first portion may be provided along the entire length of the through conductor. Thus, cracks in the element body caused by changes in temperature can be more reliably suppressed.

The first portion may be disposed spaced from the pair of end surfaces. In this case, the first portion is not exposed at the end surfaces. If the first portion is exposed at the end surfaces, the plating solution will tend to enter inside the element body from the exposed portions of the first portion during the forming of an external electrode. The plating solution that has entered inside the element body may gasify and eject out of the element body during solder mounting to cause solder burst. Such solder burst can be suppressed in the inductor above.

### BRIEF DESCRIPTION OF THE DRAWINGS

FIG. 1 is a perspective view illustrating an inductor according to a first embodiment.

FIG. 2 is a perspective view illustrating the inductor of FIG. 1.

FIG. 3 is a cross-sectional view illustrating the inductor of FIG. 1.

FIG. 4 is a cross-sectional view illustrating the inductor of FIG. 1.

FIG. 5 is a perspective view illustrating an inductor according to a second embodiment.

FIG. 6 is a cross-sectional view illustrating the inductor of FIG. 5.

FIG. 7 is a cross-sectional view illustrating an inductor according to a third embodiment.

FIG. 8 is a cross-sectional view illustrating an inductor according to a fourth embodiment.

### DETAILED DESCRIPTION

Embodiments of the present invention will be described in detail below with reference to the accompanying drawings. Same reference signs are given to the same or corresponding elements in the description of the drawings, and redundant description will be omitted.

### First Embodiment

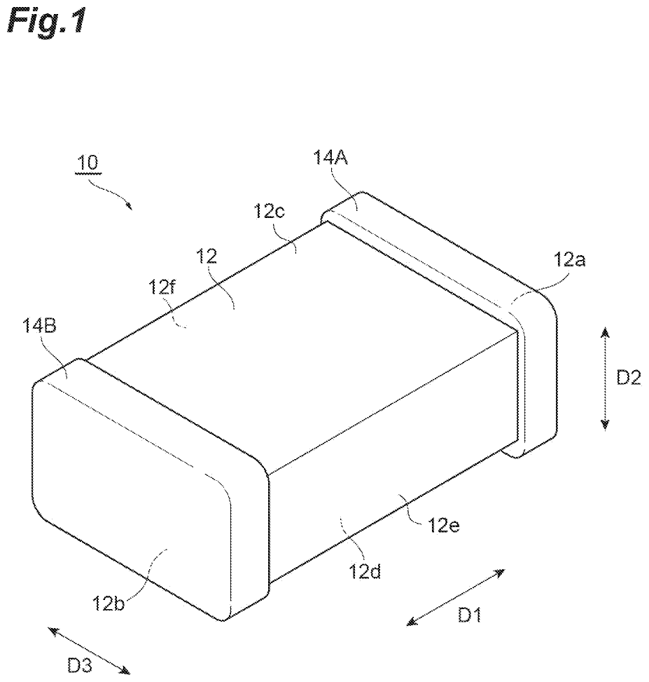

FIG. 1 is a perspective view illustrating an inductor according to a first embodiment. As illustrated in FIG. 1, an inductor 10 according to the first embodiment includes an element body 12, a pair of external electrodes 14A, 14B, and a through conductor 16. The inductor 10 is, for example, a multilayer inductor.

The element body 12 has a rectangular parallelepiped external shape. The rectangular parallelepiped shape includes a rectangular parallelepiped shape in which the corners and edges are chamfered, and a rectangular parallelepiped shape in which the corners and edges are rounded. The element body 12 has, as its external surfaces, a pair of end surfaces 12a, 12b facing each other, a pair of side surfaces 12c, 12d facing each other, and a pair of side surfaces 12e, 12f facing each other. Each of the side surfaces 12c, 12d, 12e, 12f extends in a facing direction of the pair of end surfaces 12a, 12b so as to connect the pair of end surfaces 12a, 12b.

The side surface 12d is a mounting surface that faces a mounting substrate when the inductor 10 is mounted. The side surface 12c facing the side surface 12d becomes a top surface when the inductor 10 is mounted. Hereinafter, the facing direction of the pair of end surfaces 12a, 12b is a first direction D1, the facing direction of the pair of side surfaces 12c, 12d is a second direction D2, and the facing direction of the pair of side surfaces 12e, 12f is a third direction D3. The first direction D1, the second direction D2, and the third direction D3 are perpendicular to each other.

Assuming that the dimension of the element body 12 in the first direction D1 is a length, the dimension of the element body 12 in the third direction D3 is a width, and the dimension of the element body 12 in the second direction D2 is a thickness, the element body 12 has dimensions, for example, of length 2.5 mm×width 2 mm×thickness 0.85 mm. In this embodiment, the element body 12 is designed such that the width is greater than the thickness. The element body 12 is also designed such that the length is greater than the width. Each of the end surfaces 12a, 12b has a rectangular shape in which the second direction D2 is a short side direction and the third direction D3 is a long side direction.

The element body 12 has a plurality of element body layers (not shown) that are stacked in the first direction D1. That is, the first direction D1 is a stacking direction of the plurality of element body layers. In the actual element body 12, the plurality of element body layers are integrated such that the boundaries between the layers cannot be visually recognized. The number of the element body layers that form the element body 12 is, for example, 150. Each of the element body layers has a thickness (length in the first direction D1), for example, of 1 μm or more and 100 μm or less. The element body 12 is formed of a magnetic material such as ferrite. The element body 12 is obtained by stacking and firing a plurality of magnetic patterns to be the element body layers. The magnetic patterns are formed into a desired pattern by a printing method using, for example, a magnetic paste (e.g., ferrite paste). That is, the element body 12 has a printed multilayer structure.

The pair of external electrodes 14A, 14B are provided respectively on the pair of end surfaces 12a, 12b of the element body 12. The pair of external electrodes 14A, 14B are electrically connected to the through conductor 16. The external electrode 14A is provided on the end surface 12a and covers the entirety of the end surface 12a. The external electrode 14A integrally covers the end surface 12a and end portions of the side surfaces 12c, 12d, 12e, 12f adjacent the end surface 12a. The external electrode 14B is provided on the end surface 12b and covers the entirety of the end surface 12b. The external electrode 14B integrally covers the end surface 12b and end portions of the side surfaces 12c, 12d, 12e, 12f adjacent the end surface 12b.

Each of the external electrodes 14A, 14B is formed of one or a plurality of electrode layers. A metal material such as Ag or a resin electrode material may be employed as the electrode material that forms each of the external electrodes 14A, 14B. Each of the external electrodes 14A, 14B is formed including, for example, a sintered metal layer and a plated layer covering the sintered metal layer.

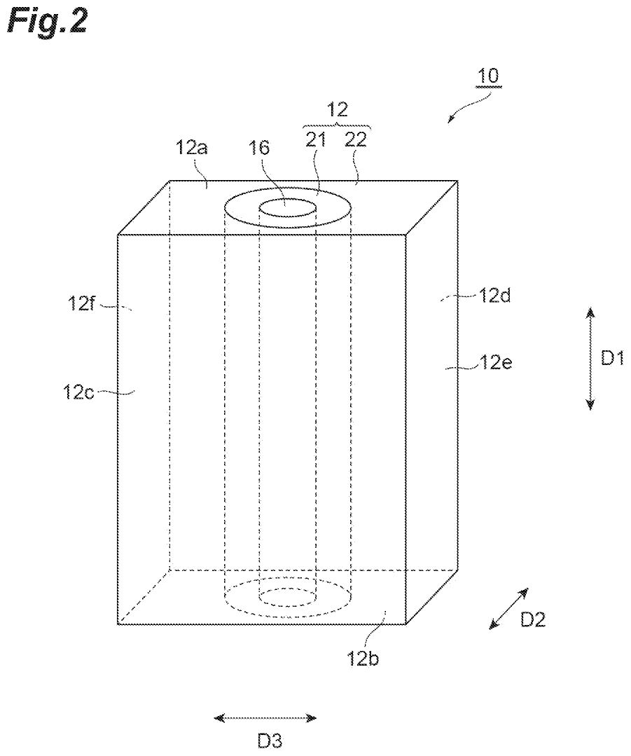

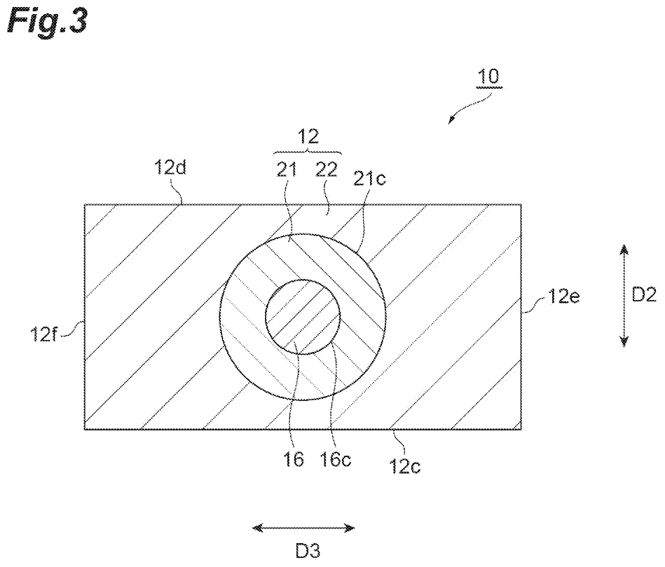

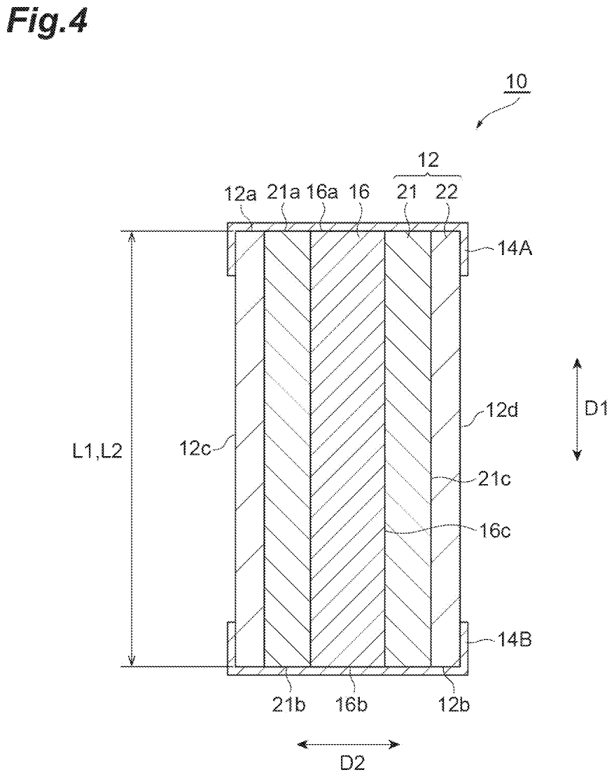

FIG. 2 is a perspective view illustrating the inductor of FIG. 1. Illustration of the external electrodes 14A, 14B is omitted in FIG. 2. FIGS. 3 and 4 are cross-sectional views illustrating the inductor of FIG. 1. FIG. 3 shows a cross-sectional view perpendicular to the first direction D1. FIG. 4 shows a cross-sectional view perpendicular to the third direction D3. As illustrated in FIGS. 2 to 4, the through conductor 16 is disposed inside the element body 12 and extends in the first direction D1. The through conductor 16 reaches from the end surface 12a to the end surface 12b. The through conductor 16 has a columnar shape in which the first direction D1 is an axial direction. The through conductor 16 has a diameter, for example, of 0.4 mm. A length L1 of the through conductor 16 in the first direction D1 is equal to the length of the element body 12 in the first direction D1.

The through conductor 16 has a pair of end surfaces 16a, 16b and a side surface 16c. The pair of end surfaces 16a, 16b face each other in the first direction D1. The end surface 16a is exposed at the end surface 12a and is bonded to the external electrode 14A. The end surface 16b is exposed at the end surface 12b and is bonded to the external electrode 14B. The side surface 16c extends in the first direction D1 so as to connect the pair of end surfaces 16a, 16b. The side surface 16c is an outer circumferential surface of the through conductor 16. The side surface 16c is an outer edge of the through conductor 16 when viewed in the first direction D1.

The through conductor 16 is disposed spaced from the side surfaces 12c, 12d, 12e, 12f, and is not exposed at the side surfaces 12c, 12d, 12e, 12f. The through conductor 16 is disposed in a center portion of the element body 12 in the second direction D2 and a center portion of the element body 12 in the third direction D3. That is, a separation distance between the through conductor 16 and the side surface 12c is equal to a separation distance between the through conductor 16 and the side surface 12d. A separation distance between the through conductor 16 and the side surface 12e is equal to a separation distance between the through conductor 16 and the side surface 12f. A separation distance herein refers to the shortest separation distance.

The through conductor 16 is formed of a conductive material including metal such as Ag. The through conductor 16 is formed, for example, by filling a through hole provided in the element body layers with a conductive paste and firing the same. The through conductor 16 may have a plurality of conductive layers (not shown) that are stacked together with the element body layers. In this case, the number of the conductive layers forming the through conductor 16 is the same as the number of the element body layers forming the element body 12. The through conductor 16 is obtained by stacking and firing a plurality of conductive patterns to be the conductive layers. The conductive patterns are formed into a desired pattern by a printing method using, for example, a conductive paste. That is, the through conductor 16 may have a printed multilayer structure similarly to the element body 12.

The element body 12 includes a first portion 21 and a second portion 22. The first portion 21 surrounds the through conductor 16 when viewed in the first direction D1. The first portion 21 is provided in contact with the side surface 16c. The first portion 21 is disposed spaced from the side surfaces 12c, 12d, 12e, 12f, and is not exposed at the side surfaces 12c, 12d, 12e, 12f.

The first portion 21 has a pair of end surfaces 21a, 21b and a side surface 21c. The pair of end surfaces 21a, 21b face each other in the first direction D1. The end surface 21a is exposed at the end surface 12a and is covered by the external electrode 14A. The end surface 21b is exposed at the end surface 12b and is covered by the external electrode 14B. The side surface 21c extends in the first direction D1 so as to connect the pair of end surfaces 21a, 21b.

The first portion 21 has a cylindrical shape inside of which the through conductor 16 is disposed and in which the first direction DI is an axial direction. The first portion 21 is disposed so as to be coaxial with the through conductor 16. The first portion 21 has an outer diameter, for example, of 0.7 mm. The side surface 21c is an outer circumferential surface of the first portion 21. The side surface 21c is an outer edge of the first portion 21 when viewed in the first direction D1. A length L2 of the first portion 21 in the first direction D1 is equal to the length L1 of the through conductor 16 in the first direction D1. The first portion 21 is provided along the entire length of the through conductor 16 in the first direction D1.

The outer edge (side surface 21c) of the first portion 21 has a similar shape to the outer edge (side surface 16c) of the through conductor 16 such that the thickness of the first portion 21 is uniform when viewed in the first direction D1. The first portion 21 covers the entire region of the side surface 16c with a uniform thickness. Here, “uniform” includes a manufacturing error and, for example, the difference between a maximum value and a minimum value is 10% or less. Although the outer edge (side surface 21c) of the first portion 21 and the outer edge (side surface 16c) of the through conductor 16 have a circular shape when viewed in the first direction DI in this embodiment, even if they have another shape such as a rectangular or elliptical shape, the thickness of the first portion 21 can be uniform as long as they have a similar shape.

The second portion 22 is disposed outward of the first portion 21 when viewed in the first direction D1. The second portion 22 surrounds the first portion 21 when viewed in the first direction D1. The second portion 22 is provided in contact with the side surface 21c of the first portion 21. The second portion 22 forms the entirety of each of the side surfaces 12c, 12d, 12e, 12f.

The first portion 21 has a porosity that is higher than a porosity of the second portion 22. That is, the element body 12 has many holes formed in the vicinity of the through conductor 16. In general, the smaller the particle size of ferrite particles and the greater the specific surface area (SSA), the smaller the gaps between the ferrite particles, so that holes do not tend to remain after sintering. Consequently, for example, setting the particle size of the ferrite particles to be used for forming the first portion 21 to be greater than the particle size of the ferrite particles to be used for forming the second portion 22 enables the porosity of the first portion 21 to be higher than the porosity of the second portion 22. The porosity may be controlled by methods other than controlling the particle size of the ferrite particles. The porosity is obtained, for example, by image analysis of a cross-sectional image of the element body 12.

In this embodiment, although the first portion 21 and the second portion 22 have different porosities, they are formed of the same magnetic material. The first portion 21 and the second portion 22 may be formed of different magnetic materials.

As described above, in the inductor 10, the porosity of the first portion 21 surrounding the through conductor 16 is higher than the porosity of the second portion 22 positioned outward of the first portion 21. Generally, in a ceramic material, the Young's modulus decreases as porosity increases. The thermal shrinkage of the through conductor 16 is higher than the thermal shrinkage of the element body 12, so that the through conductor 16 contracts more than the element body 12 when returning from a high temperature to a normal temperature. Thus, tensile stress caused by the through conductor 16 is applied to the element body 12. The Young's modulus of the first portion 21 is lower than the Young's modulus of the second portion 22, so that the first portion 21 tends to deform in line with the through conductor 16. Thus, the first portion 21 is capable of relieving the tensile stress applied to the element body 12 via thermal shrinkage of the through conductor 16. As a result, cracks in the element body 12 caused by changes in temperature can be suppressed.

The first portion 21 is disposed spaced from the side surfaces 12c, 12d, 12e, 12f, and is not exposed at the side surfaces 12c, 12d, 12e, 12f. In a configuration in which the first portion 21 is exposed at the side surfaces 12c, 12d, 12e, 12f, given that the first portion 21 includes many holes, cracks may form due to impact on the exposed portions, or corrosion may occur due to foreign substances such as moisture entering the exposed holes. The inductor 10 does not have such exposed portions on the side surfaces 12c, 12d, 12e, 12f, and is thus capable of suppressing cracks and corrosion caused by the exposed portions.

The outer edge of the first portion 21 has a similar shape to the outer edge of the through conductor 16 when viewed in the first direction D1. The first portion 21 is thus capable of covering the periphery of the through conductor 16 with a uniform thickness. Consequently, cracks in the element body 12 caused by changes in temperature can be more reliably suppressed. The first portion 21 is in contact with the side surface 16c of the through conductor 16. Consequently, cracks in the element body 12 caused by changes in temperature can be more reliably suppressed.

Since the length L1 is equal to the length L2, the first portion 21 can be provided along the entire length of the through conductor 16 in the first direction D1. Consequently, cracks in the element body 12 caused by changes in temperature can be more reliably suppressed. The element body 12 includes the plurality of element body layers that are laminated in the first direction D1. Forming each of the element body layers by a printing method facilitates forming of the first portion 21 and the second portion 22 into desired shapes.

### Second Embodiment

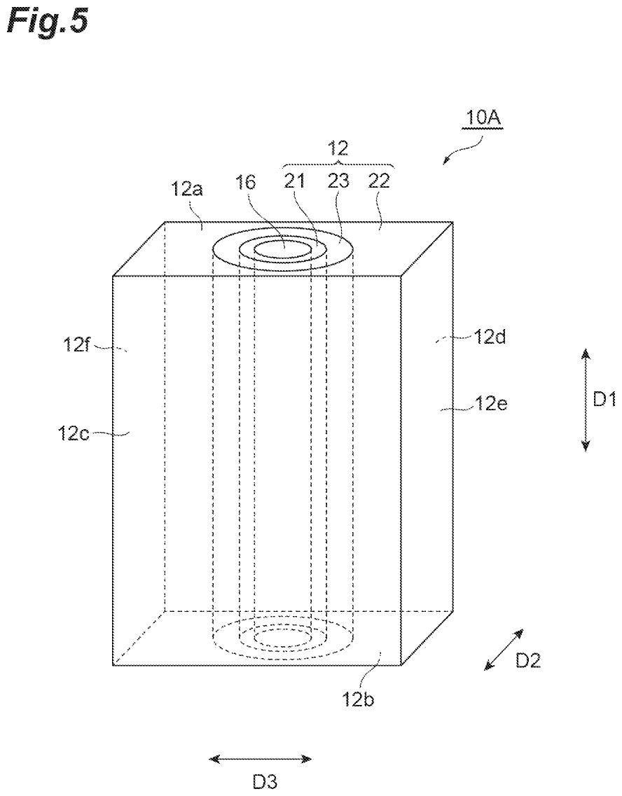

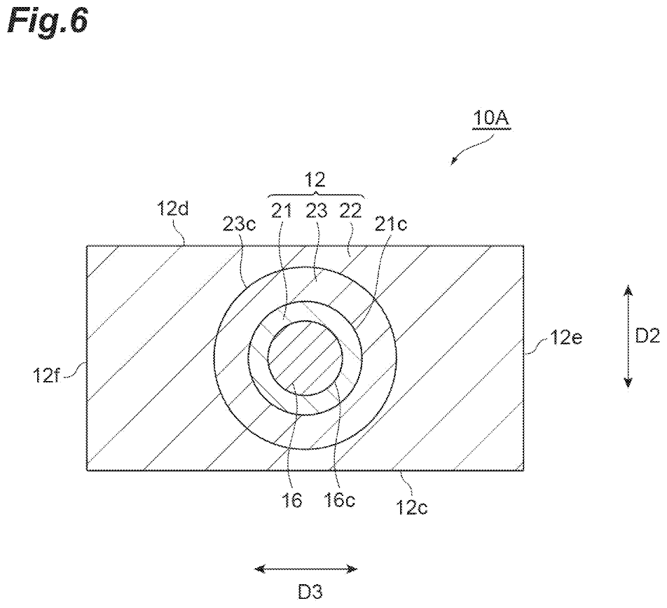

FIG. 5 is a perspective view illustrating an inductor according to a second embodiment. Illustration of the external electrodes 14A, 14B is omitted in FIG. 5. FIG. 6 is a cross-sectional view illustrating the inductor of FIG. 5. FIG. 6 shows a cross-sectional view perpendicular to the first direction D1. As illustrated in FIGS. 5 and 6, an inductor 10A according to the second embodiment is different from the inductor 10 according to the first embodiment in that the element body 12 further includes a third portion 23. The inductor 10A will be described below focusing on the difference from the inductor 10.

The third portion 23 is disposed between the first portion 21 and the second portion 22 when viewed in the first direction D1. The third portion 23 surrounds the first portion 21 when viewed in the first direction D1. The third portion 23 is provided in contact with the side surface 21c of the first portion 21. The third portion 23 is disposed spaced from the side surfaces 12c, 12d, 12e, 12f, and is not exposed at the side surfaces 12c, 12d, 12e, 12f.

The third portion 23 has a pair of end surfaces 23a, 23b and a side surface 23c. The pair of end surfaces 23a, 23b face each other in the first direction D1. The end surface 23a is exposed at the end surface 12a and is covered by the external electrode 14A. The end surface 23b is exposed at the end surface 12b and is covered by the external electrode 14B. The side surface 23c extends in the first direction D1 so as to connect the pair of end surfaces 23a, 23b.

The third portion 23 has a cylindrical shape inside of which the through conductor 16 and the first portion 21 are disposed, and in which the first direction D1 is an axial direction. The third portion 23 is disposed so as to be coaxial with the through conductor 16 and the first portion 21. The third portion 23 has an outer diameter, for example, of 0.7 mm. In this case, the first portion 21 has an outer diameter, for example, of 0.55 mm. The side surface 23c is an outer circumferential surface of the third portion 23. The side surface 23c is an outer edge of the third portion 23 when viewed in the first direction D1. A length of the third portion 23 in the first direction D1 is equal to the length L1 of the through conductor 16 (see FIG. 4) and the length L2 of the first portion 21 (see FIG. 4). The third portion 23 is provided along the entire length of the through conductor 16 and the first portion 21 in the first direction D1.

The outer edge (side surface 23c) of the third portion 23 has a similar shape to the outer edge (side surface 21c) of the first portion 21 such that the thickness of the third portion 23 is uniform when viewed in the first direction D1. The third portion 23 covers the entire region of the side surface 21c with a uniform thickness. It can be said that the third portion 23 covers the entire region of the side surface 16c together with the first portion 21 with a uniform thickness. Here, “uniform” includes a manufacturing error and, for example, the difference between a maximum value and a minimum value is 10% or less.

The third portion 23 is disposed in the center portion of the element body 12 in the second direction D2 and the center portion of the element body 12 in the third direction D3. That is, a separation distance between the third portion 23 and the side surface 12c is equal to a separation distance between the third portion 23 and the side surface 12d. A separation distance between the third portion 23 and the side surface 12e is equal to a separation distance between the third portion 23 and the side surface 12f. The second portion 22 is disposed outward of the first portion 21 and the third portion 23, and surrounds the first portion 21 and the third portion 23 when viewed in the first direction D1. The second portion 22 is provided in contact with the side surface 23c of the third portion 23.

The third portion 23 has a porosity that is lower than the porosity of the first portion 21 and higher than the porosity of the second portion 22. That is, the element body 12 is formed such that the porosity gradually increases toward the through conductor 16. For example, the porosity of the third portion 23 can be made lower than the porosity of the first portion 21 and higher than the porosity of the second portion 22 by setting the particle size of the ferrite particles to be used for forming the third portion 23 to be smaller than the particle size of the ferrite particles to be used for forming the first portion 21, and greater than the particle size of the ferrite particles to be used for forming the second portion 22.

In this embodiment, although the first portion 21, the second portion 22, and the third portion 23 have different porosities, they are formed of the same magnetic material. The first portion 21, the second portion 22, and the third portion 23 may be formed of different magnetic materials.

The first portion 21 also has a porosity that is higher than the porosity of the second portion 22 in the inductor 10A. Thus, cracks in the element body 12 caused by changes in temperature can be suppressed. The third portion 23 has a porosity that is lower than the porosity of the first portion 21 and higher than the porosity of the second portion 22. Consequently, cracks in the element body 12 caused by changes in temperature can be more reliably suppressed.

### Third Embodiment

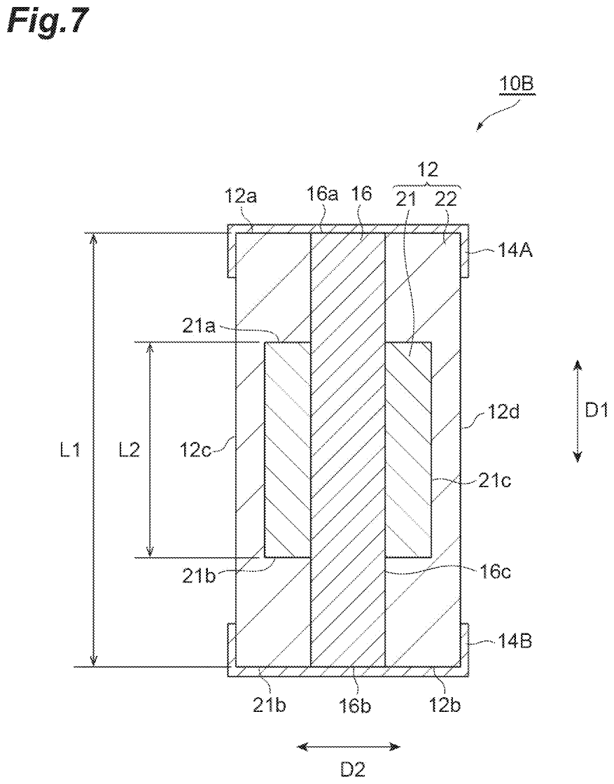

FIG. 7 is a cross-sectional view illustrating an inductor according to a third embodiment. FIG. 7 shows a cross-sectional view perpendicular to the third direction D3. As illustrated in FIG. 7, an inductor 10B according to the third embodiment is different from the inductor 10 according to the first embodiment in that the length L2 is less than the length L1. The inductor 10B will be described below focusing on the difference from the inductor 10.

The first portion 21 covers a portion of the region of the side surface 16c in the first direction D1, and not the entire region of the side surface 16c. The first portion 21 is disposed spaced from the pair of end surfaces 12a, 12b. The pair of end surfaces 21a, 21b is covered by the second portion 22, and is not exposed at the pair of end surfaces 12a, 12b. The first portion 21 is disposed in a center portion of the element body 12 in the first direction DI. That is, a separation distance between the first portion 21 and the end surface 12a is equal to a separation distance between the first portion 21 and the end surface 12b.

The first portion 21 also has a porosity that is higher than the porosity of the second portion 22 in the inductor 10B. Thus, cracks in the element body 12 caused by changes in temperature can be suppressed. The first portion 21 is disposed spaced from the pair of end surfaces 12a, 12b. Thus, the first portion 21 is not exposed at the pair of end surfaces 12a, 12b. If the first portion 21 is exposed at the pair of end surfaces 12a, 12b, the plating solution will tend to enter inside the element body 12 from the exposed portions of the first portion 21 during the forming of the external electrodes 14A, 14B. The plating solution that has entered inside the element body 12 may gasify and eject out of the element body 12 during solder mounting to cause solder burst. Such solder burst is suppressed in the inductor 10B.

### Fourth Embodiment

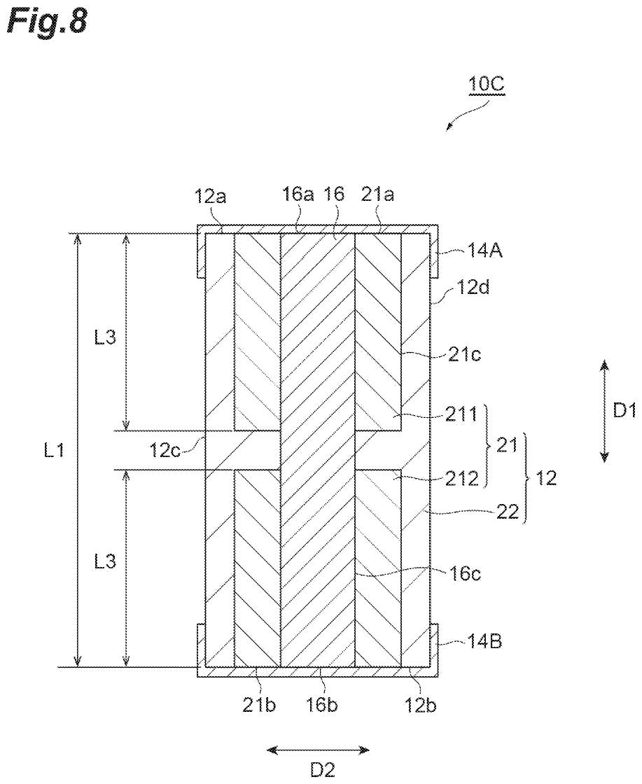

FIG. 8 is a cross-sectional view illustrating an inductor according to a fourth embodiment. FIG. 8 shows a cross-sectional view perpendicular to the third direction D3. As illustrated in FIG. 8, an inductor 10C according to the fourth embodiment is different from the inductor 10 according to the first embodiment in that the first portion 21 includes a pair of divided portions 211, 212. The inductor 10C will be described below focusing on the difference from the inductor 10.

The pair of divided portions 211, 212 is disposed spaced from each other in the first direction D1. The second portion 22 is disposed between the pair of divided portions 211, 212. The pair of divided portions 211, 212 have the same shape. The divided portion 211 includes the end surface 21a and is exposed at the end surface 12a. The divided portion 212 includes the end surface 21b and is exposed at the end surface 12b. A length L3 of each of the divided portions 211, 212 in the first direction D1 is less than the length L1. The length L3 is less than half of the length L1.

The first portion 21 also has a porosity that is higher than the porosity of the second portion 22 in the inductor 10C. Thus, cracks in the element body 12 caused by changes in temperature can be suppressed.

Although the embodiments of the present invention have been described above, the present invention is not necessarily limited to the embodiments above, and various modifications are possible without departing from the gist thereof.

The first portion 21 may be spaced from the through conductor 16 and not be in contact with the through conductor 16. The first portion 21 is provided to surround the through conductor 16 even in this case, so that the first portion 21 is capable of relieving the tensile stress applied to the element body 12 via thermal shrinkage of the through conductor 16, and suppressing cracks in the element body 12.

Although the first portion 21 is spaced from the pair of end surfaces 12a, 12b in the inductor 10B, the first portion 21 may be exposed at the end surface 12a or the end surface 12b. The divided portions 211, 212 may be respectively spaced from the end surfaces 12a, 12b in the inductor 10C. The first portion 21 may have three or more divided portions spaced from each other in the first direction D1 in the inductor 10C. The plurality of the divided portions may have different shapes from each other.

The embodiments and variations above may be combined as appropriate.

What is claimed is:

1. An inductor comprising:
an element body having a pair of end surfaces facing each other, and a side surface extending in a facing direction of the pair of end surfaces to connect the pair of end surfaces; and
a through conductor disposed inside the element body and extending in the facing direction,
wherein the element body includes a first portion surrounding the through conductor, and a second portion positioned outward of the first portion, when viewed in the facing direction,
wherein the first portion is disposed spaced from the side surface, and
wherein the first portion has a porosity higher than a porosity of the second portion.

2. The inductor according to claim 1,
wherein the element body further includes a third portion disposed between the first portion and the second portion, and
wherein the third portion has a porosity lower than the porosity of the first portion and higher than the porosity of the second portion.

3. The inductor according to claim 1, wherein an outer edge of the first portion has a similar shape to an outer edge of the through conductor when viewed in the facing direction.

4. The inductor according to claim 1, wherein the first portion is in contact with the through conductor.

5. The inductor according to claim 1, wherein a length of the first portion in the facing direction is equal to a length of the through conductor in the facing direction.

6. The inductor according to claim 1, wherein the first portion is disposed spaced from the pair of end surfaces.

7. The inductor according to claim 1, wherein the through conductor has a columnar shape in which the facing direction is an axial direction.

8. The inductor according to claim 1, wherein a thermal shrinkage of the through conductor is higher than a thermal shrinkage of the element body.

9. The inductor according to claim 1, wherein a thermal shrinkage of the through conductor is higher than a thermal shrinkage of the element body.

10. The inductor according to claim 1, wherein the element body includes a plurality of element body layers that are stacked in the facing direction.

11. The inductor according to claim 1, further comprising a pair of external electrodes provided on the pair of end surfaces.

12. An inductor comprising:
an element body having a pair of end surfaces facing each other, and a side surface extending in a facing direction of the pair of end surfaces to connect the pair of end surfaces;
a through conductor disposed inside the element body and extending in the facing direction, and
a pair of external electrodes provided on the pair of end surfaces,
wherein the element body includes a first portion surrounding the through conductor, and a second portion positioned outward of the first portion, when viewed in the facing direction,
wherein the first portion is disposed spaced from the side surface, and
wherein the first portion has a porosity higher than a porosity of the second portion.
